(19) United States
(12) Patent Application Publication
(10) Pub. No.: US 2021/0227371 A1
(43) Pub. Date: Jul. 22, 2021

(54) METHOD, APPARATUS AND COMPUTER-READABLE MEDIUM FOR EVENT RESPONSE

(71) Applicant: Bryx, Inc., Rochester, NY (US)

(72) Inventor: David Thomas, Rochester, NY (US)

(21) Appl. No.: 17/132,249

(22) Filed: Dec. 23, 2020

Related U.S. Application Data
(60) Provisional application No. 62/952,687, filed on Dec. 23, 2019.

(51) Int. Cl. H04W 4/90; G08B 27/00; G06F 16/9535; H04L 29/08

(52) U.S. Cl. CPC H04W 4/90; G08B 27/005; H04L 67/306; G06F 16/9535; G08B 27/006

(57) ABSTRACT

Embodiments of the present disclosure provide a method, apparatus and computer-readable medium for event response. An exemplary method includes transmitting, by a processor, a profile questionnaire to a plurality of user equipments, and receiving, by the processor, a plurality of profiles from the plurality of user equipments. The method further includes receiving, by the processor, an indication that at least one of the plurality of user equipments are located within a predetermined geographic area. The method still further includes receiving, by the processor, an alert, and determining, by the processor, a plurality of instructions for each one of the at least one of the plurality of user equipments based on the received plurality of profiles, and transmitting, by the processor, a plurality of instructions to the at least one of the plurality of user equipments.

### BACKGROUND OF THE INVENTION

### Field of the Invention

The present disclosure relates to a method, apparatus and computer-readable medium for event response, and more particularly to improved emergency response at an event.

### Description of Related Art

Emergency responders are trained to respond to emergency situations including mass casualty events. This training includes the ability to treat medical injuries and to transport individuals that require medical attention to the proper medical treatment facility, such as a hospital or other trauma treatment center. Some of the types of emergency responders or first responders include EMTs, doctors, nurses, police officers, fire fighters, etc.

### BRIEF SUMMARY OF THE INVENTION

In view of the foregoing, it is an object of the present disclosure to provide a method, apparatus, and computer-readable medium for responding to an event.

A first exemplary embodiment of the present disclosure provides a method for event response. The method includes transmitting, by a processor, a profile questionnaire to a plurality of user equipments. The method further includes receiving, by the processor, a plurality of profiles from the plurality of user equipments, and receiving, by the processor, an indication that at least one of the plurality of user equipments are located within a predetermined geographic area. The method further includes receiving, by the processor, an alert, and determining, by the processor, a plurality of instructions for each one of the at least one of the plurality of user equipments based on the received plurality of profiles. The method still further includes transmitting, by the processor, a plurality of instructions to the at least one of the plurality of user equipments.

A second exemplary embodiment of the present disclosure provides an apparatus. The apparatus includes at least one processor and a memory storing computer program instructions executable by the at least one processor, wherein the memory and the computer program instructions and the processor are configured to cause the apparatus to at least transmit a profile questionnaire to a plurality of user equipments, and receive a plurality profiles from the plurality of user equipments. The apparatus is further caused to receive an indication that at least one of the plurality of user equipments are located within a predetermined geographic area, and receive an alert. The apparatus is still further caused to determine a plurality of instructions for each one of the at least one of the plurality of user equipments based the received plurality of profiles, and transmit a plurality of instructions to the at least one of the plurality of user equipments.

A third exemplary embodiment of the present disclosure provides a non-transitory computer-readable medium. A non-transitory computer-readable medium tangibly comprising computer program instructions, which, when executed by a processor, causes the processor to at least transmit a profile questionnaire to a plurality of user equipments, and receive a plurality profiles from the plurality of user equipments. The processor is further caused to receive an indication that at least one of the plurality of user equipments are located within a predetermined geographic area, and receive an alert. The processor is still further caused to determine a plurality of instructions for each one of the at least one of the plurality of user equipments based the received plurality of profiles, and transmit a plurality of instructions to the at least one of the plurality of user equipments.

The following will describe embodiments of the present disclosure, but it should be appreciated that the present disclosure is not limited to the described embodiments and various modifications of the disclosure are possible without departing from the basic principle. The scope of the present disclosure is therefore to be determined solely by the appended claims.

### BRIEF DESCRIPTION OF THE SEVERAL VIEWS OF THE DRAWING(S)

FIG. 1 presents a cross-sectional view of an exemplary device suitable for use in practicing exemplary embodiments of this disclosure.

FIG. 2 presents a logic flow diagram suitable for use in performing exemplary embodiments of the present disclosure.

FIG. 3 presents an exemplary device with user profile information suitable for use in performing exemplary embodiments of the present disclosure.

FIG. 4 presents an exemplary device with questions for a user suitable for use in performing exemplary embodiments of the present disclosure.

FIG. 5 presents an exemplary device with a question for a user suitable for use in performing exemplary embodiments of the present disclosure.

FIG. 6 presents an exemplary device with exemplary user instructions suitable for use in performing exemplary embodiments of the present disclosure.

FIG. 7 presents an exemplary UAS suitable for use in performing exemplary embodiments of the present disclosure.

FIG. 8 presents an exemplary block diagram illustrating exemplary devices suitable for use in performing exemplary embodiments of the present disclosure.

### DETAILED DESCRIPTION OF THE INVENTION

Safety and security in particular locations or during events having large numbers of people in attendance is paramount to the prevention of mass casualty events. However, no security system nor precautions taken are able to prevent each and every mass casualty scenario. Accordingly, the existence of prepared plans can be invaluable during the circumstances in which an unforeseen mass casualty or emergency event occurs. Yet, even the best laid plans cannot predict all of the possible scenarios that can occur, which means that the prepared plans for responding to emergency events or mass casualty events may or may not provide the best means for responding to such an event.

There are a number of problems with most response plans to emergencies. First, each plan can only consider a finite number of possible emergencies. This means that there are a number of scenarios in which the response plan is not the proper or optimal response strategy for responding to that particular emergency. Some of the examples of the shortcomings of a given plan can involve (i) not having the right number (too many or too little) of emergency personnel to respond, (ii) not having the right emergency personnel in the right location to respond, (iii) not having the emergency personnel respond at the right time, and (iv) not being able to communicate with or communicating the wrong instructions to non-emergency personnel.

In addition to these inherent issues with any preset plan to respond to emergency situations, there are inherent untapped resources for responding in any given emergency situation. These untapped resources are the non-emergency individuals who have skills that may be useful in responding to the emergency. Embodiments of the present disclosure provide a method, apparatus and computer-readable medium for aiding in responding to emergency events and/or mass casualty events.

Embodiments of the present disclosure provide a method, apparatus and computer-readable medium for responding to emergency events and/or mass casualty situations. Embodiments provide the ability to receive the skills, abilities, disabilities, and locations of individuals such that those individual's skills, abilities, disabilities, and locations can be used to determine an optimal response strategy for responding to emergency situations and/or mass casualty events. Embodiments also provide the ability to provide instructions to individuals who are unofficial emergency personnel during or after an emergency situation such that those unofficial emergency personnel can help respond to the emergency situation or can be efficiently relocated from the site of the emergency situation.

Embodiments provide an application that can be downloaded onto a plurality of user equipments (e.g., UE 106, UE 108, UE 110, UE 112). Embodiments of the user equipment include any electronic device, mobile phone, smartphone, computer, and/or wearable device. The application will cause the UEs 106, 108, 110, 112 to ask the user to provide information/user profile regarding the user. Embodiments of the information can pertain to the profession of the user, the skills of the user (e.g., medical training, military training, law enforcement training), the physical abilities or physical limitations of the user, and known medical conditions of the user. The application will also cause the user equipments 106, 108, 110, 112 to ask the user to opt-in or opt-out to (1) sharing the information that the user provides with the server 102, and (2) receiving instructions, information and updates following or during an emergency event.

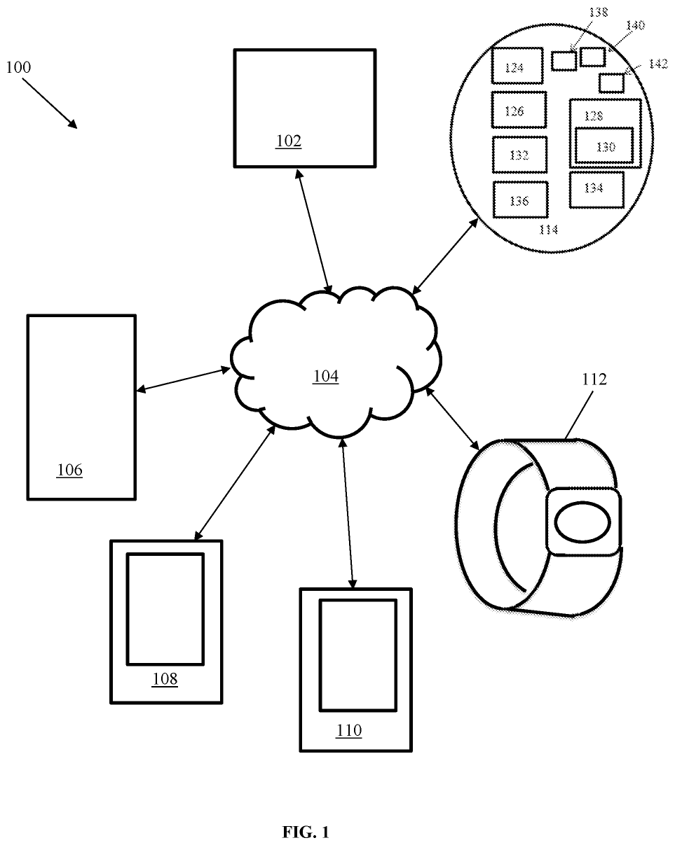

Referring to FIG. 1, shown is an exemplary signaling diagram of the devices suitable for performing exemplary embodiments of the present disclosure. Shown in FIG. 1 is system 100 having server 102, internet/server 104, UE 106, UE 108, UE 110, and smartwatch 112. Server 102 can include one server or a plurality of servers. Embodiments of server 102 can be located at a 911 dispatch center and can be integrated with the 911 dispatch center. In another embodiment, server 102 is not integrated with a 911 dispatch center and is separate from the 911 dispatch center, but is operable to communicate with the 911 dispatch center through wired or wireless communication networks. Server 102 is operable to communicate with internet/server 104, UE 106, UE 108, UE 110, and smartwatch 112. Although FIG. 1 only depicts internet/server 104, UE 106, UE 108, UE 110, and smartwatch 112, it should be appreciated server 102 is operable to communicate with more or less devices depicted in FIG. 1. For example, UE 106 is represented by a single device in FIG. 1. However, it should be appreciated that UE 106 is representative of first responder systems. As such, server 102 is operable to communicate with a plurality of first responders through UE 106. Embodiments of server 102 include at least one processor, at least one memory operable to maintain computer program instructions, which when executed by the at least one processor cause it to perform embodiments of this disclosure. Embodiments of server 102 further include a receiver and a transmitter for receiving information or data either by wired or wireless connections to and from Internet/Server 104.

In an embodiment, server 102 includes or has access to geographic map information, the location of hospitals, the location of first responders (e.g., firefighters, ambulance services), the location of police stations, the location of potential emergency command locations, and the location of buildings and other structures. Server 102 may maintain information regarding the user associated with UE 108, UE 110, and smartwatch 112 (e.g., location, skills, medical conditions, etc.) such that it can determine which user (if any) can be used or be helpful in responding to an emergency situation or mass casualty event, which user (if uninjured) has the physical mobility to reach certain emergency locations (e.g., hospitals, police stations, etc.), and which users (whether injured or not) will not have the physical mobility to reach certain emergency locations. Server 102 is also operable to communicate with first responder systems UE 106 (e.g., police systems, hospitals, hospital systems, firefighters and other first responders) such that it can deliver information of the users of UE 106, UE 108, UE 110, and smartwatch 112 to the first responders or so that it can deliver information regarding the first responders to UE 106, UE 108, UE 110, and smartwatch 112.

Internet/Server 104 includes the internet or it can include one or multiple public or private servers that are operable to send and receive data with each of the devices or elements illustrated in FIG. 1. For example, Internet/Server 104 can include one or multiple processors, one or multiple memories storing computer program instructions, and one or more transmitters or receivers for transmitting or receiving information or data via a wired or wireless connection.

Embodiments of UE 108, and UE 110 include smartphones, cell phones, tablets, laptop computers, desktop computer and the like. Embodiments of UE 108, and UE 110 each include at least one processor, at least one memory storing computer program instructions, a user interface which may include a display and the ability to transmit and receive data (either via wired or wireless connections) with server 102 or directly with any of the other elements depicted in FIG. 1. Smartwatch 112 is a specific embodiment of an exemplary UE operable to function similar to UE 106, UE 108, and UE 110. Embodiments of smartwatch 112 include a processor, a memory storing computer program instructions and is operable to transmit and receive data from the other elements depicted in FIG. 1. UE 106 is representative of one or more emergency systems such as 911 dispatch systems, police systems, fire fighter systems, hospital systems, and/or military systems. Embodiments of UE 106 can include one or more servers each having one or more processors, one or more memories storing computer program instructions that when executed by the one or more processors cause the UE 106 to perform embodiments described herein. Embodiments of UE 106 include one or more transmitter and receivers that are operable to communicate with internet/server 104 and the other devices depicted in FIG. 1.

Also shown in FIG. 1 is unmanned aircraft system (UAS) 114. UAS 114 is operable to fly from one location to another. UAS 114 is a drone having a processor 124, a memory 128 storing computer program instructions 130, a transmitter 138, a receiver 140, a capture device 126, a battery 132, a motor or motors 134, and a plurality of propellers 136. It should be appreciated that embodiments of UAS 114 include the plurality of propellers 136 being replaced with a fixed wing system. UAS 114 also includes global positioning system (GPS) functionality such that it can independently communicate with the GPS network to determine their location with respect to a specified location, such as the location of an emergency, an individual or a UE. UAS 114 is operable to fly independently or without manual user control through the combination of battery 132 operably to power the motor or motors 134. The motor or motors 134 are operable to rotate the plurality of propellers 136 to allows UAS 114 to fly. The memory 128 storing computer program instructions 130 when executed on the processor 124 is operable to cause the motor or motors 134 to operate the plurality of propellers 136 in a fashion desired to move the UAS 114 in a particular direction, at a particular height and at a particular speed. Each processor 124 in UAS 114 is operable to fly the UAS 114 as desired. UAS 114 is operable to communicate with server 102 such that it can send and receive data including at least (i) data gathered by the capture device, (ii) flight path instructions, and (iii) updated flight path information. For instance, UAS 114 is operable to receive a flight path or flight path instructions from server 102. The flight path provides instructions that allow and direct UAS 114 to (i) launch from a launch site, (ii) fly or travel from the launch site to a specific location (e.g., the location of an emergency situation), (iii) circle the specific location and obtain information about the specific location using the capture device 126, and (iv) return to launch site.

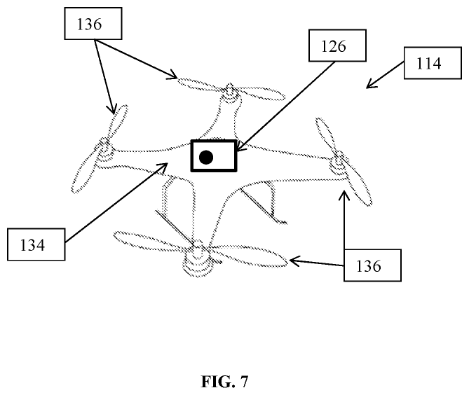

UAS 114 is operable to transmit any and all gathered information from capture device 126 to server 102. In one embodiment, UAS 114 is operable to transmit any and all gathered information from capture device 126 to server 102. Embodiments of capture device 126 include cameras, microphones, video cameras, gas sensors, and light and infrared sensors. Embodiments of capture device 126 are operable to obtain one or a plurality of photographs, video, audio, gas sensor information, infrared sensor information, and light sensor information. Shown in FIG. 7 is an exemplary UAS 114. As depicted in FIG. 7, UAS 114 includes a body 134, a capture device 126 and propellers 136. UAS 114 also includes at least one processor, at least one memory storing computer program instructions and a transmitter/receiver.

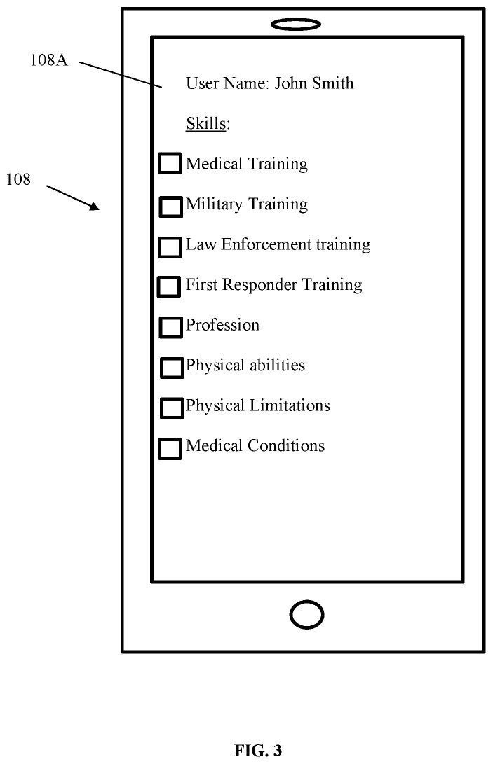

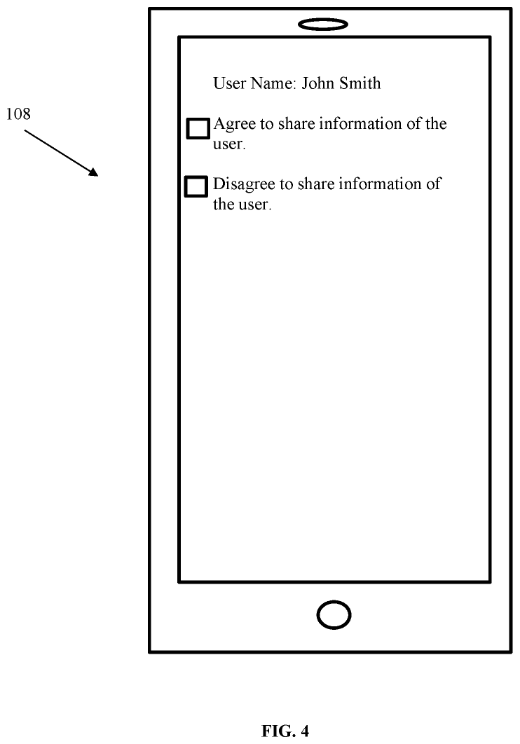

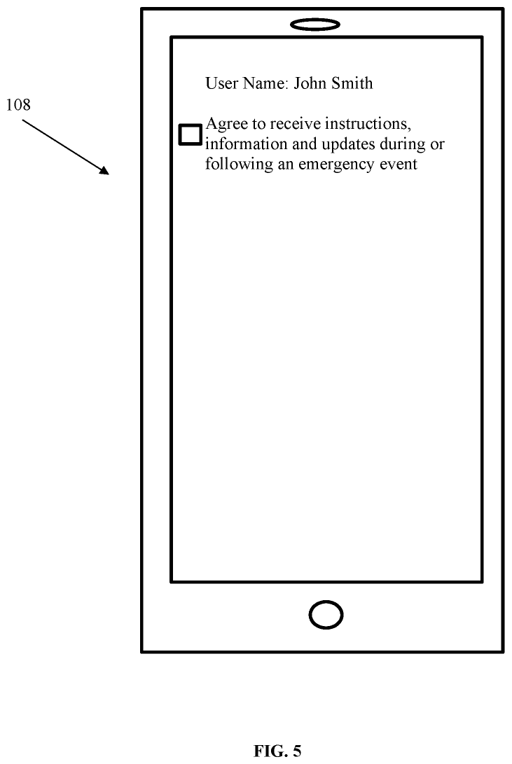

In practice, each UE 108, 110, and 112 will download an application that will allow a user to provide information about the user of that particular UE. Shown in FIG. 3 is an exemplary UE 108 having a user interface 108A. Each UE including UE 108 is operable when running the application, to prompt the user of the UE 108 to provide information about the user to create a profile of the user. For instance, as shown in FIG. 3, the user will be prompted to provide information regarding the user's medical training, military training, law enforcement training, first responder training, profession, physical abilities (e.g., ability to walk, run, carry objects or people, see, hear, etc.), physical limitations (e.g., wheel chair bound, walking stick needed, prosthetic limbs, blindness, deafness, etc.), and existing medical conditions (e.g., heart conditions, blood pressure conditions, blood type, diabetic, chronic diseases, etc.). The UE 108 will receive the provided information from the user. The user will then be prompted to agree to share the information or disagree to share the information and with whom (shown in FIG. 4). In one embodiment, the user will allow the application to share the user's information only in the instance that there is an emergency or mass casualty event. In this embodiment, UE 108 will transmit the user's responses to server 102. Server 102 will be prevented from sharing the information with any other device or person until an event occurs at which point, server 102 will be allowed to use and/or access the user's information. In another embodiment, UE 108 will not transmit the user's responses to the server 102, but will maintain the user's responses/information locally in the memory of UE 108. The UE 108 will then automatically transmit the user's responses/information to server 102 following an emergency or mass casualty event. In another embodiment, UE 108 will prompt the user to allow it to transmit the user's responses/information to server 102 before transmitting the responses/information. The user of UE 108 will also be prompted to agree to receive instructions, information and updates during or following an emergency event (shown in FIG. 5). If the user agrees to receive instructions, information and updates during or following an emergency event, server 102 will provide instructions, information and updates during or following an emergency event as described herein.

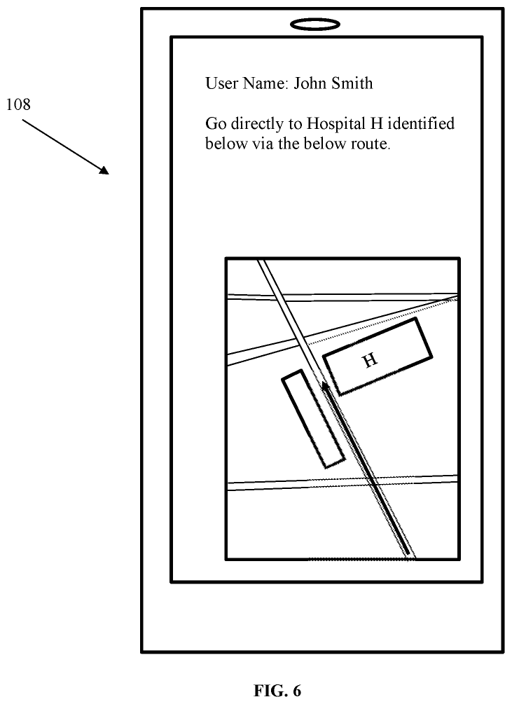

Once the user provides their responses or allows the UE to transmit the user responses to the server 102 (include GPS information regarding the location of the particular UE), the server 102 will receive all of the information provided by UEs 108, 110, and 112. The server 102 will analyze the information including the location of each of the UEs 108, 110, and 112. When an emergency situation or mass casualty event occurs, the server 102 will receive information through 911 dispatch (e.g., from UE 106) and other emergency systems regarding the emergency situation or mass casualty event. The server 102 will then analyze the information and data it receives regarding the emergency situation or mass casualty event. The server 102 will then determine personalized instructions for each of the users of UEs 108, 110, and 112 based on (i) the received information from the UEs 108, 110, and 112, (ii) the analyzed data regarding the emergency situation, (iii) the location of the UEs 108, 110, and 112, (iv) the location and availability for local hospitals or other medical facilities to accommodate patients, and (v) the location, and medical skill sets of first responders and other official emergency personnel. The server 102 will then send the determined personalized instructions to one or more of the UEs 108, 110 and 112. Embodiments of instructions includes (i) instructions as to which hospital or medical facility to go to (shown in FIG. 6), (ii) instructions to go to a particular location and provide particular medical or law enforcement support, or (iii) instructions for leaving the location of the emergency situation. Embodiments also include server 102 instructing the user of a UE to help wounded individuals in a particular area because that user has specialized medical training. In another embodiment, server 102 may instruct a user of a UE to help in the evacuation of wounded individuals because the user is physically able to carry or help move individuals. In yet another embodiment, server 102 may instruct a user to not move from their present location because that individual has certain physical limitations. In this instance, server 102 may transmit the user's location to first responders so that the first responders can get to the user quicker. Embodiments of the present disclosure thus allow a centralized or decentralized system to analyze data associated with individuals who are located at or near an emergency event such that those individuals can either be more effectively evacuated or be more effectively used in response to the emergency event.

In one embodiment server 102 is operable to transmit location information to UAS 114 such that UAS 114 can fly to the location of the emergency event or mass casualty event. UAS 114 will then travel to the location and transmit back to server 102 video, photographs, audio and other information captured by the capture device 126. Server 102 is operable to use the captured information in determining the instructions it provides to the users of UEs 108, 110, and 112. For example, the users of UEs 108, 110, and 112 may receive instructions initial to proceed to the nearest hospital following a mass casualty event. However, server 102 may provide updated information/instructions to the users of UEs 108, 110, and 112 if the captured information from UAS 114 indicates that there is an accident on the road leading the hospital or that one of the users of UEs 108, 110, and 112 is injured. In that instance, server 102 may provide instructions to that particular UE to proceed to a closer rally point where first responders can help get that user to the hospital.

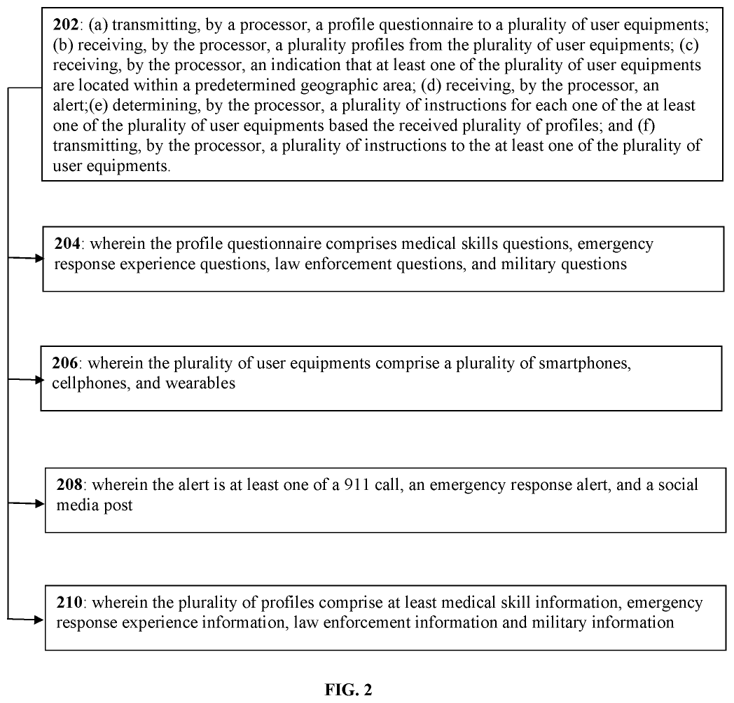

Reference is now made to FIG. 2, which depicts a logic flow diagram suitable for practicing exemplary embodiments of the present disclosure. Beginning at block 202 it states (a) transmitting, by a processor, a profile questionnaire to a plurality of user equipments; (b) receiving, by the processor, a plurality profiles from the plurality of user equipments; (c) receiving, by the processor, an indication that at least one of the plurality of user equipments are located within a predetermined geographic area; (d) receiving, by the processor, an alert;(e) determining, by the processor, a plurality of instructions for each one of the at least one of the plurality of user equipments based the received plurality of profiles; and (f) transmitting, by the processor, a plurality of instructions to the at least one of the plurality of user equipments. The block 204 states wherein the profile questionnaire comprises medical skills questions, emergency response experience questions, law enforcement questions, and military questions.

Following block 204, block 206 indicates wherein the plurality of user equipments comprise a plurality of smartphones, cellphones, and wearables. Next block 208 relates to wherein the alert is at least one of a 911 call, an emergency response alert, and a social media post. Block 210 specifies wherein the plurality of profiles comprise at least medical skill information, emergency response experience information, law enforcement information and military information.

The logic flow diagram of FIG. 2 may be considered to illustrate the operation of a method, apparatus, or a result of execution of computer program instructions stored in a computer-readable medium. The logic flow diagram of FIG. 2 may also be considered a specific manner in which components of a device or devices are configured to operate, whether such device is an electronic device, laptop, tablet, server, desktop, mobile phone, smartphone, wearable device, or one or more components thereof. The various blocks shown in FIG. 2 may also be considered as a plurality of coupled logic circuit elements constructed to carry out the associated function(s), or specific result of strings of computer program instructions or code stored in memory.

Various embodiments of the computer-readable medium include any data storage technology type which is suitable to the local technical environment, including but not limited to semiconductor based memory devices, magnetic memory devices and systems, optical memory devices and systems, fixed memory, removable memory, disc memory, flash memory, dynamic random-access memory (DRAM), static random-access memory (SRAM), electronically erasable programmable read-only memory (EEPROM) and the like. Various embodiments of the processor include but are not limited to general purpose computers, special purpose computers, microprocessors digital signal processors and multi-core processors.

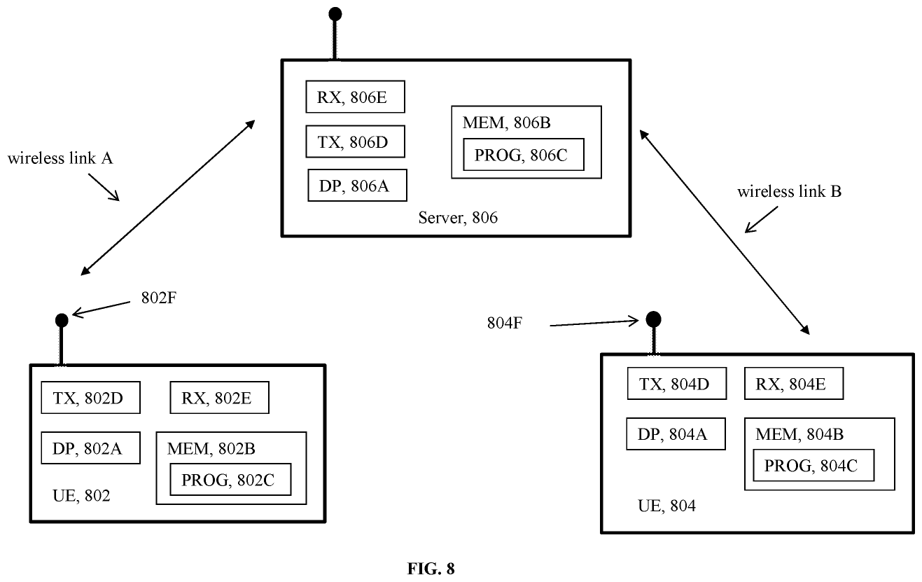

Reference is now made to FIG. 8, which illustrates a simplified block diagram of the various electronic devices and apparatus that are suitable for use in practicing exemplary embodiments of the present disclosure. In FIG. 8, server 806 is adapted for communication over wireless link A with UE 806. Server 806 is adapted for communication over wireless link B with UE 804. In other exemplary embodiments, server 806 can communicate with UE 802 ad UE 804 through wired connections, wireless connection, or a combination of both. Server 806 may include single server or a plurality of servers.

Server 806 includes processing means such as a processing system and/or at least one data processor (DP) 806A, storing means such as at least one computer-readable memory (MEM) 806B storing at least one computer program (PROG) 806C, and communicating means such as a transmitter (TX) 806D and a receiver (RX) 806E for bidirectional wireless communications with other devices as known in the art.

UE 802 may include processing means such as a processing system or at least one data processor (DP) 802A, storing means such as at least one computer-readable medium or computer-readable memory (MEM) 802B storing at least one computer program (PROG) 802C, and also communicating means such as a transmitter (TX) 802D and receiver (RX) 402E for bidirectional wireless communications with server 806 and/or UE 804 and/or any other UE's (not shown) via one or more antennas 802F as known in the art.

Similarly, UE 804 includes processing means such as a processing system and/or at least one data processor (DP) 804A, storing means such as at least one computer-readable medium (MEM) 804B storing at least one computer program (PROG) 804C, and communicating means such as a transmitter (TX) 804D and a receiver (RX) 804E for bidirectional wireless communications (e.g., through cellular, WIFI, Bluetooth, etc.) with other devices via one or more antennas 804F as known in the art. Various embodiments of UE 802 and UE 804 can include, but are not limited to cellular telephones, mobile phones, smartphones, smart watches, laptop computers, personal portable digital devices having wireless communication capabilities including but not limited to laptop/palmtop/tablet computers, digital cameras and internet appliances.

At least one of the PROGs 802C or 804C in UEs 802, 804 includes program instructions that, when executed by the associated DP 802A, 804A, enable the device to operate in accordance with embodiments of the present invention, as detailed above. Server 806 may also have software stored in its MEM 806B to implement certain aspects of these teachings. Embodiments of this disclosure may be implemented at least in part by computer software stored in the MEM 802B, 804B, 806B which is executable by DP 802A of UE 802, DP 804A of UE 804, and/or DP 806A of server 806, or by hardware, or by a combination of tangibly stored software and hardware (and tangibly stored firmware). Electronic devices implementing these aspects of the disclosure need not be the entire devices as depicted in FIG. 8, but embodiments may be implemented by one or more components of same such as the above described tangibly stored software, hardware, firmware, and DP, or a system on a chip, an application specific integrated circuit ASIC or a digital signal processor DSP.

Various embodiments of the computer readable MEMs 802B, 804B, and 8406B include any data storage technology which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 802A, 804A, and 806A include but are not limited to general purpose computers, special purpose computers, microprocessors, digital signal processors (DSPs) and multi-core processors.

It is to be understood that any feature described in relation to any one embodiment may be used alone, or in combination with other features described, and may also be used alone, or in combination with one or more features of any other of the embodiments, or any combination of any other of the embodiments. The presently disclosed embodiments are therefore considered in all respects to be illustrative. Furthermore, equivalents and modifications not described above may also be employed without departing from the scope of this disclosure, which is defined in the accompanying claims.

1. A method for event response, the method comprising:
(a) transmitting, by a processor, a profile questionnaire to a plurality of user equipments;
(b) receiving, by the processor, a plurality of profiles from the plurality of user equipments;
(c) receiving, by the processor, an indication that at least one of the plurality of user equipments are located within a predetermined geographic area;
(d) receiving, by the processor, an alert;
(e) determining, by the processor, a plurality of instructions for each one of the at least one of the plurality of user equipments based on the received plurality of profiles; and
(f) transmitting, by the processor, a plurality of instructions to the at least one of the plurality of user equipments.

2. The method according to claim 1, wherein the profile questionnaire comprises medical skills questions, emergency response experience questions, law enforcement questions, and military questions.

3. The method according to claim 1, wherein the plurality of user equipments comprise a plurality of smartphones, cellphones, and wearables.

4. The method according to claim 1, wherein the alert is at least one of a 911 call, an emergency response alert, and a social media post.

5. The method according to claim 1, wherein the plurality of profiles comprise at least medical skill information, emergency response experience information, law enforcement information and military information.

6. An apparatus comprising at least one processor and a memory storing computer program instructions executable by the at least one processor, wherein the memory and the computer program instructions and the processor are configured to cause the apparatus to at least:
(a) transmit a profile questionnaire to a plurality of user equipments;
(b) receive a plurality profiles from the plurality of user equipments;
(c) receive an indication that at least one of the plurality of user equipments are located within a predetermined geographic area;
(d) receive an alert;
(e) determine a plurality of instructions for each one of the at least one of the plurality of user equipments based the received plurality of profiles; and
(f) transmit a plurality of instructions to the at least one of the plurality of user equipments.

7. The apparatus according to claim 6, wherein the profile questionnaire comprises medical skills questions, emergency response experience questions, law enforcement questions, and military questions.

8. The apparatus according to claim 6, wherein the plurality of user equipments comprise a plurality of smartphones, cellphones, and wearables.

9. The apparatus according to claim 6, wherein the alert is at least one of a 911 call, an emergency response alert, and a social media post.

10. The apparatus according to claim 6, wherein the plurality of profiles comprise at least medical skill information, emergency response experience information, law enforcement information and military information.

12. A non-transitory computer-readable medium tangibly comprising computer program instructions, which, when executed by a processor, causes the processor to at least:
(a) transmit a profile questionnaire to a plurality of user equipments;
(b) receive a plurality profiles from the plurality of user equipments;
(c) receive an indication that at least one of the plurality of user equipments are located within a predetermined geographic area;
(d) receive an alert;
(e) determine a plurality of instructions for each one of the at least one of the plurality of user equipments based the received plurality of profiles; and
(f) transmit a plurality of instructions to the at least one of the plurality of user equipments.

13. The non-transitory computer-readable medium according to claim 12, wherein the profile questionnaire comprises medical skills questions, emergency response experience questions, law enforcement questions, and military questions.

14. The non-transitory computer-readable medium according to claim 12, wherein the plurality of user equipments comprise a plurality of smartphones, cellphones, and wearables.

15. The non-transitory computer-readable medium according to claim 12, wherein the alert is at least one of a 911 call, an emergency response alert, and a social media post.

16. The non-transitory computer-readable medium according to claim 12, wherein the plurality of profiles comprise at least medical skill information, emergency response experience information, law enforcement information and military information.
